(19) United States
(12) Patent Application Publication
(10) Pub. No.: US 2011/0289086 A1
(43) Pub. Date: Nov. 24, 2011

(54) SYSTEM, METHOD AND APPARATUS FOR DATA ANALYSIS

(76) Inventors: Philip Martin Jordan, Auckland (NZ); Vilosh Marion Brito, Windlesham (GB)

(21) Appl. No.: 13/112,427

(22) Filed: May 20, 2011

Related U.S. Application Data
(60) Provisional application No. 61/347,224, filed on May 21, 2010.

(51) Int. Cl. G06F 17/30

(52) U.S. Cl. 707/737; 707/E17.046

(57) ABSTRACT

A system and method for searching a database for multiple entries in the database that contain similar data, in which some embodiments of the method include collating data on physical sites from at least one database source to form a collation of site data, assigning a unique entry identifier to each entry of the site data in the collation, performing a lexical analysis of the site data and assigning a similarity metric(s) to each entry of the site data, sorting site data into at least one group with similar lexical content based on a metric threshold difference analysis of the similarity metric(s), to thereby provide at least one group, having at least one site data entry therein, and wherein where there are two or more site data entries in the at least one group, preferably they refer to the same site or to sites having a similar physical address.

### CROSS-REFERENCE TO RELATED APPLICATIONS

This application claims the benefit of U.S. Provisional Patent Application Ser. No. 61/347,224, filed on May 21, 2010, the entire contents of which are incorporated in their entirety by reference herein.

### TECHNICAL FIELD OF THE INVENTION

The present invention relates generally to database analysis and database content correlation, and more particularly, although not exclusively, to database analysis and database content correlation for telecommunication and address databases to identify multiple data entries for the same physical site.

### BACKGROUND OF THE INVENTION

Telecommunication operators hold source data in databases that contain information about aspects of their customers or installations of the telecommunications operator's product or services. This source data may contain tens of hundreds or tens of thousands or more physical site data entries that refer to connections, installations or equipment at physical sites. Each physical site has a physical address that describes its location, such as a street address (often traditional postal style addresses are used, but various textual descriptions can be used).

This site data is captured in many ways and then entered into the database. Databases also may be inherited or supplied from other operators. Each of the many ways of capturing and the record structure of site data produces slight variations in the site data that is captured. Site data that is captured is often considered “dirty” for a number of reasons. Some of these reasons include:
System or database migrations often include re-keying, and non-local geographic knowledge when re-keying often increases the chance of errors.
Data movements particularly from disparate system often results in source fields being copied into incorrect fields in the target database. Sometime fields are merged together as part of the migration (when an exact mapping cannot be defined) and hence information is lost.
Optical character recognition capturing, especially of paper invoices and assumptions thereof.
If address data is entered freeform (often parsed to lines) it has problems.
Solutions based around address parsing and validation at entry time suffer from a different set of problems including enumeration lists of options not containing the require value, and entry of data into an incorrect field.
Engineering teams often make notes “on site”. This often means hand written data. Transcription of handwritten data has a mediocre fidelity.
Different databases used may have differing formats for the way in which data is stored, for example one may have individual entry fields for street, number and suburb, others may have this as a single field for a physical location.

Normally, telecommunication operators use address cleaning methods to ensure the site data once entered is for a physical address of a real site, and is as “clean” as possible. However the physical address is of limited utility as a source of saving or optimization for the telecommunication operators. These are generally based around geographic distance from “Points of Presence” known as POPs, which are exchanges from local lines to trunk lines.

For an existing database of tens of thousands or hundreds of thousands of entries such checking is difficult and expensive. The problem is easy if done as the database is built or as individual entries are added to a database. Such is disclosed in U.S. Pat. No. 5,799,302 which, as customer data is entered into a database by an operator a “nickname” is identified and then the operator is presented with the same or similar data that already exists in the database that has the same or similar nickname. The operator then has the option to merge or otherwise the new information. This is a front end method that is very user heavy and therefore is expensive in human time as each record as it is entered into a system is visually checked by the operator.

What is required is enabling the telecommunication operators to correlate the data. This means enabling the telecommunication operators and staff to know whether two or more site data entries in their database or in multiples databases they access, that vary in their form are in fact for the same physical site or for two different physical sites that happen to share a similar address. Once two or more entries in the data are known to be the same physical location there are many optimizations that are available; description of these optimizations are not necessary for understanding this invention. It is the finding of these duplications this invention is directed to.

For example, “100 G St, Portland” and “G Street 100, Portland” are in fact the exact same site. This example is a trivial case and would likely be correlated by looking the address up in an address cleaning service, for example Address Doctor® or Google Maps®.

There are many options available to attempt to automate the marking of similar data within a database. However it must be noted that undetected false positives have a huge negative value attached to them and must be avoided. This means a system that is 95% correct automatically has place 5% false positives into the system, which will outweigh the value of the 95% correct matching. In all cases known to the authors of this invention this limitation means that thresholds for matching must be set so high that the automated system is unlikely to solve more than 50% of correlation marking.

All data must be compared with all other data in order to find matches. This means as a first method that for each of 10,000 sites the operator must manually review 9,999 other sites. Obviously at any size above say 100 this is unfeasible.

A simplistic method to do this might be to present the data base site or address data in alpha-numeric sorted order. But as can be clearly seen from the above example, this would only allow the operator to review a few sites together and they would need to review all the data again to truly find correlations.

A further option is to try and write algorithms to parse the functional parts of the database site data separately into street number, street name, suffix, postcode, etc. The operator or computer can then sort the data based on that. This requires tens of hundreds of man days on any significant size of database (tens of thousands), and still does not allow the operator to see all possibly related sites in a single page or glance.

It is therefore desired and has been a long felt want to be able to analyse vast databases to look for and provide correlations for the same or similar information across different entries. If such analysis can provide a human or other analyst a less than N-squared number of entries to review this is desirable.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is an object of the present invention to provide an improved method for database analysis, or to overcome the above shortcomings or address the above desiderata, or to at least provide the public with a useful choice.

### SUMMARY OF EMBODIMENTS OF THE INVENTION

A first aspect of an embodiment of the present invention may consist in a method of analysing a database or databases where said database, or databases, contains site data for physical sites, where some site data may be duplicate data for the same site, said method comprising or including the steps of: assigning a unique entry identifier to each piece of said site data to be analysed, choosing a first piece of said site data, performing a lexical similarity analysis of said first piece against at least one other piece of said site data and assigning at least one similarity metric from said lexical similarity analysis to said at least one other piece of said site data, sorting said site data into at least one group including said first piece and other site data having similar lexical content based on a metric threshold difference analysis of said at least one similarity metric, wherein where there are two or more entries of said site data in said at least one group those entries refer to the same said physical site or to physical sites having a similar physical address.

Preferably, prior to performing said lexical similarity analysis there may be a step of collating data on physical sites from at least one said database source to form a collation of site data.

Preferably, the method may be repeated for each piece of site data to be analysed.

Preferably, the at least one group is analysed to determine if any entry in said at least one group is the same or similar as any other entry in said at least one group.

Preferably, if said entries in said at least one group are for different said physical sites then said metric threshold difference analysis is adjusted and said lexical similarity analysis is re-run until multiple entries in said at least one group refer to the same said physical site.

Preferably, said entries that are the same or similar are flagged for further analysis.

Preferably, said analysis of said at least one group, is conducted by a human operator utilising any one or more of the following: a computer terminal, an interactive terminal, or via a printout.

Preferably, there may be multiple said groups formed one each for said physical site and any multiple entries in any one said group are for the same physical site.

Preferably, where there are multiples entries in said at least one group said database or said databases are amended to account for said duplicate data.

Preferably, said further sorting is based on, any one or more of: the number of site data in each group, or the similarity of site data in each group.

Preferably each said at least one group is assigned a unique group identifier.

Preferably said at least one similarity metric is a normalised similarity metric.

Preferably said metric threshold can be varied between 0 and 1.

Preferably, said piece for analysis from said site data can be chosen from any one or more of the following: owner name, street entry (number and name), street or road names, street or road numbers or equivalent, suburb, town, postcode, state, phone, facsimile or mobile numbers, or email address.

Preferably, each street entry in each site data undergoes said lexical similarity analysis against all other site data street entries and a street entry normalized similarity metric is produced.

Preferably, each site locality entry in each site data undergoes said lexical similarity analysis against all other site data sites locality entries and a site locality normalized similarity metric is produced.

Preferably, there is a street entry metric threshold, whose value ranges between 0 and 1.

Preferably, said street entry metric threshold is 0.5.

Preferably there is a site locality entry metric threshold, whose value ranges between 0 and 1.

Preferably, site locality entry metric threshold is 0.5.

Preferably, said lexical similarity analysis is chosen from any one or more of the following string matching algorithms: JaroWinklerTFIDF, Levenstein, MongeElkan, and Needleman-Wunsch.

Preferably, said lexical similarity analysis is performed by the JaroWinklerTFIDF string matching algorithm.

According to another aspect of the present invention, there is provided computerised apparatus in communication with a database and operable to perform the method defined in the immediately preceding paragraphs.

According to a further aspect of the invention, there is provided a computer program or a computer readable medium containing instructions to cause a computer to perform the method defined in the preceding paragraphs.

According to another aspect of the present invention, there is provided computerised apparatus in communication with a database and operable to perform the as herein described with reference to any one or more of the accompanying drawings.

According to a further aspect of the invention, there is provided a computer program or a computer readable medium containing instructions to cause a computer to perform the method as herein described with reference to any one or more of the accompanying drawings.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a schematic of the present invention showing the databases which contain site data with data pieces, showing how entries for the same physical site 4 may be different 3A and 3B;

FIG. 2 shows as a process chart the method of the invention, continuing on from FIG. 1; and

FIG. 3 shows operation of the method of the invention in a computer and analysis on screen or on a printout by a user.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

As used herein the term “physical site or address” preferably refers to a geographical location or locations or geographical region or regions, for example a physical street address.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present, but other features can also be present. Related terms such as “comprise” and “comprised” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

The entire disclosures of all applications, patents and publications, cited above and below, if any, are hereby incorporated by reference.

This invention may also be said broadly to consist in the parts, elements and features referred to or indicated in the specification of the application, individually or collectively, and any or all combinations of any two or more of said parts, elements and features, and where specific integers are mentioned herein which have known equivalents in the art to which this invention relates, such known equivalents are deemed to be incorporated herein as if individually set forth.

Other aspects of the invention may become apparent from the following description which is given by way of example only and with reference to the accompanying drawings.

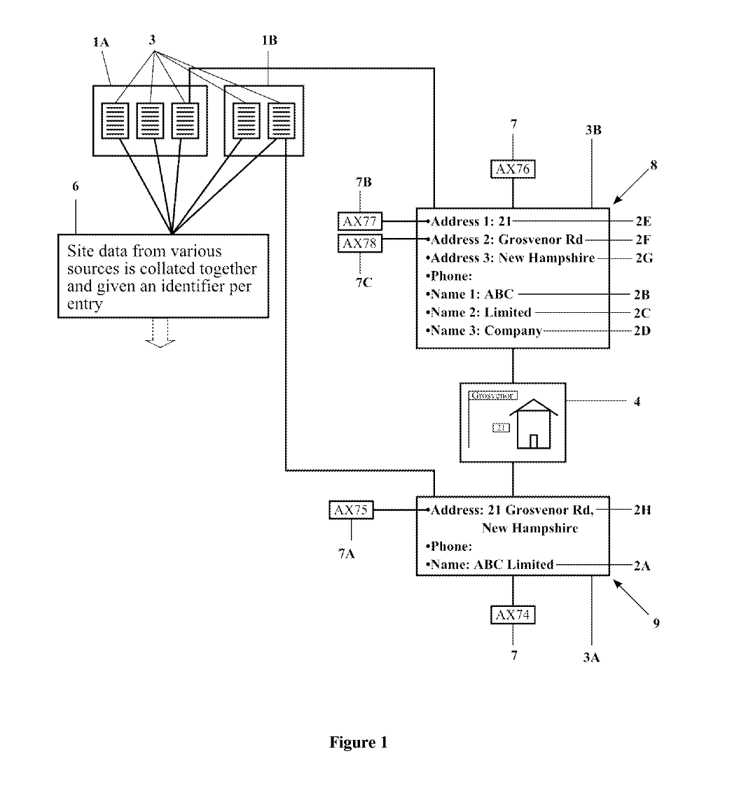

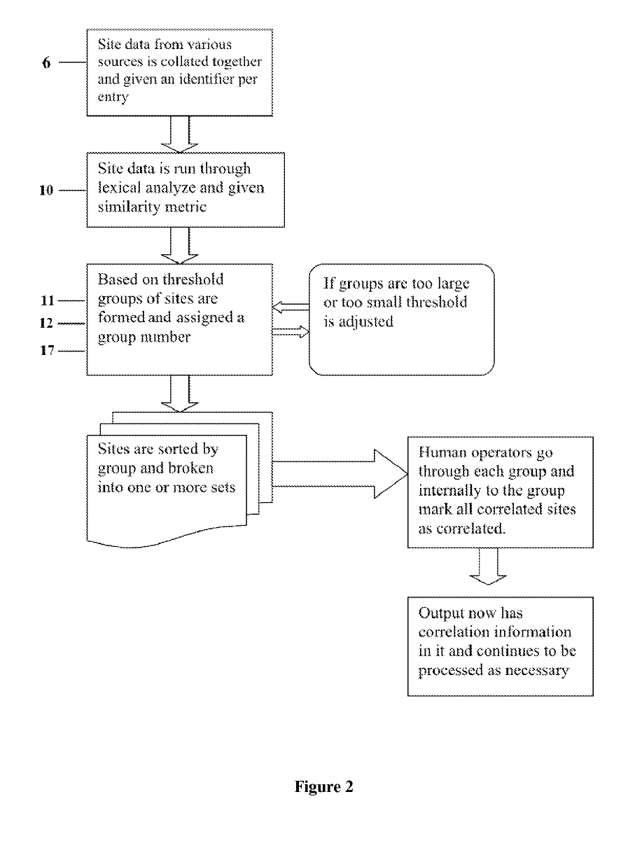

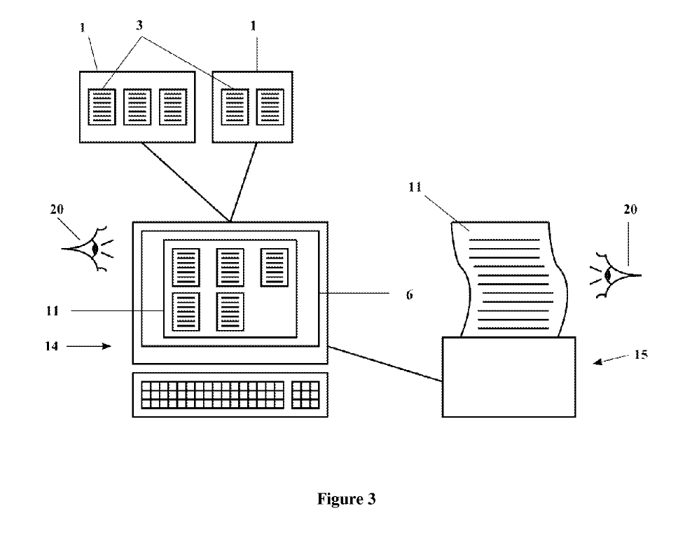

Embodiments of the invention are described herein with reference to FIG. 1 to 3.

Embodiments of the present invention may search and analyze information of data entries across one database or multiple databases to look for data entries that are duplicates for the same information. The duplicated information may be the result of data being presented or entered in differing ways, formats, fields or having spelling or entry errors (for example from optical character recognition). The similar or duplicated information will refer to the same physical address of a site. These sites normally are the location of an installation of concern to the operator or investigator of the database. For example, the operator may be a telecommunications operator that has a number of telephone or data installations located at physical sites in the real world.

As shown in FIG. 1, the method may include collating all the site data 2, or entries 3 within each site data entry, from the database or databases 1 together to form a collation of site data 6. In the preferred form of the present invention this is done on a computerised apparatus 14 such as, but not limited to a computer, for example a mainframe, remote server or cloud-cluster. Alternative forms of the present invention may be a computer program or computer readable medium to perform the method.

Site data 2 will be comprised of a number of field entries, as shown in FIG. 1. For example there maybe fields for: owner name (for example “Name” 2A, “Name 1” 2B, “Name 2” 2C, “Name 3” 2D), street entry (number and name, for example “Address” 2H), street or road numbers or equivalent (for example “Address 1” 2E), street or road names (for example “Address 2” 2F), suburb, town (for example “Address 3” 2G, postcode, state, phone, facsimile or mobile numbers, or email address.

As can be seen site data 3A and 3B in the databases 1A and 1B whilst they are separate entries actually refer to the same physical site 4, namely “21 Grosvener Red, New Hampshire” and the owner or customer is “ABC Limited” which is a company. A standard comparison between these two entries (for example if buried in 1000s of entries) would likely result in them not being identified as separate but duplicate data for the same site. Thus, for example a mailing program or site maintenance program may send two identical letters to the same site, or schedule two maintenance crews at the same time, or at differing times for the same work.

Once the preferred collation of site data is formed a unique entry identifier 7 is then assigned to each piece of site data that is to be analysed. The result is N pieces of data to be analysed.

For example if site data 3 for each physical site 4 is to be compared against all other site data as a whole then a unique entry identifier 7 (for example AX74 for one site data and AX76 for another) is assigned to each of the site data 3. Alternatively, for example if street names and numbers 2E, 2F and 2H as entries of site data are to be analysed then these are assigned each unique entry identifiers, for example AX75 7A, AX77 7B, and AX78 7C. Thus allowing each entry that is analysed (either site data as a whole, or entries within each site data) to be tracked through the analysis. This may be helpful at the collation stage and then if the data needs reassembly back into site data.

This may be further limited to comparing all road name and numbers of site data entries from a certain suburb or town, for example when two or more suburb or towns have the same road name, such as Main Street.

A first piece of site data 8 is then chosen (whether a site data as a whole, or an entry therein). A lexical similarity analysis is then performed on at least one other site data 9 of preferably each of the remaining other site data 3, as a whole, or a specific a site data 3 entry or entries 2 against one as above. This first piece of data (whether site data or site data entry) is compared to each of the other pieces of data in the collation. Thus if there are N entries to analyse this is an N squared analysis.

The lexical similarity analysis is a string matching algorithm, such as, but not limited to JaroWinklerTFIDF, Levenstein, MongeElkan, or NeedlemanWunsch algorithms. In a preferred embodiment of the present invention the JaroWinklerTFIDF string matching algorithm is used. The lexical similarity analysis outputs a measure of the similarity between two pieces of data as a similarity metric 10. The similarity metric may be for site data 3 (that is collection of information entries about a site) as a whole or may be for individual site data entries 2 in a piece of site data 3. The similarity metric 10 maybe formed as a metric for that piece of data only or as a hybrid of several (such as for the example above where you have street no., name and suburb to account for different locations with the same street name). When the lexical similarity analysis runs it compares one piece of data (first piece of data 8) against all the chosen other pieces of data in the database. For example one site data 3 as a whole against all the other site data 3, or one entry 2 in a piece of site data, for example a street name or locality against all the other entries 2 in the other pieces of site data with street names or locality entries.

In the preferred embodiment the similarity metric 10 is normalised. If for example street data entries 2E, are analysed then a street entry normalised similarity metric is produced for that entry. Likewise if site locality entries are analysed then a site locality normalised similarity metric is produced for that entry.

At least one group 11, and preferably groups 11 of analysed data (that is site data 3 entries 2 from site data 3) are then formed based on a metric threshold difference analysis of each of the similarity metrics. This means that based on a certain threshold of similarity like or similar pieces of data are placed into the same group. Each group is assigned a differing or unique group identifier 17. This may, as in a preferred embodiment be a number, but in other embodiments may be a letter, symbol or otherwise. Assignment of the group identifier may be made before or after the group is performed, or on the fly as each difference in metric similarity is found and a new group required.

A user 20 may control the method to select a similarity analysis of an address number, street, suburb, city, state, zip code, country, phone or facsimile number, or any other data piece as the priority for matching. Alternatively the method may be controlled to match each and all of these so that multiple entries for the same physical location are found.

In a preferred form of the present invention the metric threshold 12 will vary between 0 and 1. The variation will be made depending on whether the coarseness of the metric threshold 12 is too course or too fine, and this leads to too many or too few entries being grouped together. If there are too few (that is duplicates are being missed) then the grouping may be over accurate and may be not grouping entries that otherwise are similar. Alternatively if there are too many entries then the grouping is under accurate and is grouping together entries that are not similar.

In the preferred embodiment using the JaroWinklerTFIDF algorithm a threshold or 0.5 has shown good results for street or locality data.

The result will normally be a majority of groups with only a single entry. These groups reflect the data in the data base that is not duplicated. These are easily analysed further as is explained below. The groups that are of real interest are those that result in multiple entries in the group as these contain duplicate entries in the database. The further analysis is then easier as the problem is reduced after the lexical analysis and grouping based on similarity metric from an N squared problem, to for example an N-X problem where X is the number of duplications in the database(s).

The groups are then sorted if so desired. In the preferred form of the present invention the groups are ordered on the basis of the number of entries in the group (that is greatest number first and so on), but any other attribute may be used to order the groups, for example, but not limited to data entry type (e.g. an address number, street, suburb, city, state, zip code, country, phone or facsimile number), alphanumerically, or distance away from a specified location. By organising into greatest number first the groups with duplicate entries are the first to be further analysed. The remainder (single entry groups) can normally be dismissed because they do not represent a duplication in the database(s).

A user 20, for example a human operator, at a computer terminal, or other interactive means known in the art, or via a printout 15 then reviews each group to determine if any row (a single site) is in fact the same site as another row but just in a different format. The pattern matching abilities of the human brain are ideally suited to this. However other pattern matching solutions may be used, such as computerised ones.

The user 20, based on their, or the computer analysis, then flags that these are the same sites. How the user 20 does this is not important for the course of this invention. This process may also be automated if desired.

This embodiment of this invention is requires an extremely advanced pattern matching mechanism to make the decision regarding the actual correlation of 2 sites data that is presented in the one group. At present this would need to be either human brain (and hence a person) or an adequately train artificial neural network, for example http://en.wikipedia.org/wiki/Artificial_neural_network.

In the case of the neural network data presentation could potentially be random however pre-grouping the data before presentation to the NN will allow better choices and so the invention is just as relevant to this embodiment.

For humans however presentation of data for pattern matching needs to be appropriate, this is the embodiment of the invention, how to present data to the operator to elicit a useful answer within a useful timeframe.

An example of a similar problem space might be asking a human to compare hundreds of thousands of pictures tens of thousands of humans and put them into sets of the same person. Which given human visual processing capabilities is in fact an easier task that the address data problem space.

Those entries that are flagged will then have their matching entries in the database(s) amended, such as deletion, overwriting or flagging so the duplication is removed or ignored.

However, as an example we have found that a spread sheeting program, for example, Microsoft Excel® is suitable to display and sort the group sites for a user 20. Site identifiers are then used to be able to reference the original data. When cleaning the data set when two rows are determined to be the same the user 20 simply copies the better row over the worse or manually alters one to match the other.

Note that this process does not attempt to “clean” the address against any data outside the actual list or database of sites themselves, it is a self verification done internally on the information within the data base(s). As such it is in not the same as an address verification service and in one embodiment the output of this process might still be put through an address verification/cleaning process as well.

However at the end of this process, by looking at the “match” indicator (such as the “similarity metric” or a “string equals” operation) of the sites, the data now has a large portion of the correlated data indicated as such and most or all of the duplicates are removed.

In examples we have run we typically see about 25% of the data able to be correlated in this manner. There is then a further correlation once the sites have been put through an address verification service (Like Address Doctor® or Google Maps®).

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention. The foregoing description of the invention includes preferred forms thereof. Modifications may be made thereto without departing from the scope of the invention.

What is claimed is:

1. A method of analysing a database or databases where said database, or databases, contains site data for physical sites, where some site data may be duplicate data for the same site, said method comprising:
assigning a unique entry identifier to each piece of said site data to be analysed;
choosing a first piece of said site data;
performing a lexical similarity analysis of said first piece against at least one other piece of said site data and assigning at least one similarity metric from said lexical similarity analysis to said at least one other piece of said site data; and
sorting said site data into at least one group including said first piece and other site data having similar lexical content based on a metric threshold difference analysis of said at least one similarity metric,
wherein where there are two or more entries of said site data in said at least one group those entries refer to the same said physical site or to physical sites having a similar physical address.

2. A method as claimed in claim 1, wherein prior to performing said lexical similarity analysis, collating data on physical sites from at least one said database source to form a collation of site data.

3. A method as claimed in claim 1, wherein said method is repeated for each piece of site data to be analysed.

4. A method as claimed in claim 1, wherein said at least one group is analysed to determine if any entry in said at least one group is the same or similar as any other entry in said at least one group.

5. A method as claimed in claim 3, wherein if said entries in said at least one group are for different said physical sites, then said metric threshold difference analysis is adjusted and said lexical similarity analysis is re-run until multiple entries in said at least one group refer to the same said physical site.

6. A method as claimed in claim 2, wherein said entries that are the same or similar are flagged for further analysis.

7. A method as claimed in claim 3, wherein said analysis of said at least one group is conducted by a human operator utilising one or more selected from the group consisting of: a computer terminal, an interactive terminal, and via a printout.

8. A method as claimed in claim 1, wherein there are multiple said groups formed one each for said physical site and any multiple entries in any one said group are for the same physical site.

9. A method as claimed in claim 1, wherein where there are multiples entries in said at least one group, said database or said databases are amended to account for said duplicate data.

10. A method as claimed in 2, wherein said further sorting is based on, any one or more selected from the group consisting of: the number of site data in each group, and the similarity of site data in each group.

11. A method as claimed in claim 1, wherein each said at least one group is assigned a unique group identifier.

12. A method as claimed claim 1, wherein said at least one similarity metric is a normalized similarity metric that can be varied between 0 and 1.

13. A method as claimed in claim 1, wherein said piece for analysis from said site data can be chosen from any one or more selected from the group consisting of: owner name, street entry (number and name), street or road names, street or road numbers or equivalent, suburb, town, postcode, state, phone, facsimile or mobile numbers, and email address.

14. A method as claimed in claim 1, wherein each street entry in each site data undergoes said lexical similarity analysis against all other site data street entries and a street entry normalized similarity metric is produced.

15. A method as claimed in claim 1, wherein there is a street entry metric threshold, whose value ranges between 0 and 1.

16. A method as claimed in claim 15, wherein said street entry metric threshold is 0.5.

17. A method as claimed in claim 1 wherein said lexical similarity analysis is chosen from any one or more algorithm selected from the group string matching algorithms consisting of: JaroWinklerTFIDF, Levenstein, MongeElkan, and Needleman-Wunsch.

18. A method as claimed in claim 1, wherein said lexical similarity analysis is performed by the JaroWinklerTFIDF string matching algorithm.

19. A computer apparatus in communication with a database and operable to perform the method of claim 1.

20. A computer program stored on a computer readable medium containing instructions that when executed by a processor cause the processor to perform the method of claim 1.
